(19) United States
(12) Patent Application Publication
(10) Pub. No.: US 2006/0150480 A1
(43) Pub. Date: Jul. 13, 2006

(54) Landscape edging system and methods of use

(75) Inventor: Richard A. Ruller, Littleton, CO (US)

Correspondence Address: FAEGRE & BENSON LLP;PATENT DOCKETING, 2200 WELLS FARGO CENTER, 90 SOUTH 7TH STREET, MINNEAPOLIS, MN, 55402-3901, US

(73) Assignee: Colorado Metal Craft, Inc., Littleton, CO (US)

(21) Appl. No.: 11/332,384

(22) Filed: Jan. 12, 2006

Related U.S. Application Data
(60) Provisional application No. 60/643,528, filed on Jan. 12, 2005.

(51) Int. Cl. A01G 1/08

(52) U.S. Cl. 47/33; 52/102

(57) ABSTRACT

According to various embodiments of the present invention, an interlocking, modular landscape edging system is provided. Landscape edging member may have male and female ends, and include inner and outer strips. Outer strip may include top and bottom hems to retain inner strip, such that inner strip extends from outer strip to form a flange at male end. Two or more landscape edging members may be joined by inserting flange of male end into top and bottom hems of female end. A finish may be applied to landscape edging to provide color and/or to hinder environmental damage over time. Alternatively, edging member may include outer strip with flange, but no inner strip. Alternatively, edging members may include female end at both ends, and may connect to other edging members via connecting shims. Dual-pointed, U-shaped, colored landscaping pins may straddle landscape edging members and be inserted into the ground for stabilization.

### CROSS-REFERENCE TO RELATED APPLICATIONS

This application claims the benefit of U.S. Provisional Patent Application Serial No. 60/643,528, filed on Jan. 12, 2005, and entitled, “Landscape Edging System and Methods of Use.” The aforementioned application is incorporated by reference herein for all purposes.

### BACKGROUND

1. Field

Embodiments of the present invention relate generally to the field of landscaping, and more specifically to an interlocking landscape edging system for retaining landscaping material.

2. Description of Related Art

As a common practice in the art of landscaping, different landscaped areas may be divided to prevent the landscaping material of one area from spilling over into another area, or to present a distinct appearance between landscaped areas. For example, landscape edging may be used to separate grass from mulch, or to separate grass from a flower bed. This may prevent the grass from flowing over into the mulch or flower bed, and may prevent the mulch or dirt from flowing over onto the grass. Pins or stakes may be used to hold landscape edging in place. As another common practice, brick, stone or rock barriers may be built to accomplish an effect similar to that accomplished by landscape edging. When a brick, block or stone patio is built, some sort of retaining device is usually installed to prevent the material from moving, usually onto a path, but often onto grass or a flower bed.

Current edging systems provide a flimsy plastic or metal, such as black plastic, that may lend itself to undesired bending over time; such edging may fail to be aesthetically pleasing by failing to blend into the surrounding landscape design. Current edging systems also often leave a sharp top edge exposed, presenting a potential cutting hazard for humans or pets. In addition, the brick, block and stone landscaping barriers currently offered may be overly expensive or difficult and time consuming to install. Current landscaping pins typically consist of wooden or metal spikes with a single point or no point, which are typically inserted on only one side of the landscape edging and often do not blend into or match the color of the landscape edging.

### BRIEF SUMMARY

According to various embodiments of the present invention, an interlocking, modular landscape edging system is provided. A landscape edging member, according to such embodiments, has a male end and a female end, and includes an inner strip and an outer strip. The outer strip may include a top hem and a bottom hem. The top hem and bottom hem may retain the inner strip within the outer strip, such that the length of the inner strip may be offset with respect to the length of the outer strip to form the female end and a flange at the male end. Such a configuration gives the landscape edging member a modular quality that permits two or more landscape edging members to be joined by inserting the flange of the male end of one landscape edging member into the top hem and bottom hem of the female end of another landscape edging member. A finish may be applied to the landscape edging to provide color and/or to hinder environmental damage over time.

According to some embodiments of the present invention, a landscape edging member has an outer strip but no inner strip. Such a landscape edging member may have a male end and a female end. The outer strip may be bent or folded approximately one hundred eighty degrees to form a top hem and a bottom hem. Although the top hem and bottom hem may be folded completely over to contact the outer strip along most of the length of outer strip, a space may be formed under the top hem and bottom hem at the female end to allow the male end to be inserted under the top hem and bottom hem of the female end. Such a space formed under the top hem and bottom hem may extend from the female end for a length corresponding to the length of the flange of the male end. Again, such a configuration gives the landscape edging member a modular quality that permits two or more landscape edging members to be joined by inserting the flange of the male end of one landscape edging member into the top hem and bottom hem of the female end of another landscape edging member. A finish may be applied to the landscape edging to provide color and/or to hinder environmental damage over time.

According to various other embodiments of the present invention, a landscape edging member has a female end at both ends, and two or more landscape edging members may be connected using connecting shims. The connecting shims may fit under the top hem and the bottom hem of consecutive edging members, permitting the female ends of the consecutive edging members to meet upon fitting over the connecting shim.

According to yet other embodiments of the present invention, landscaping pins may be used to stabilize and increase the aesthetic appearance of landscape edging members. The landscaping pins may form an inverted U-shape with dual points configured to straddle the landscape edging member before insertion into an underlying surface, such as, for example, the ground. The landscaping pins may also have a width sufficient to at least partially cover an area where one landscape edging member joins with another. A finish may be applied to the landscaping pins to provide color and/or to hinder environmental damage over time; the color may be selected to match or complement the landscape edging members. The landscaping pins may each include a raised channel for increased strength and stability.

According to yet other embodiments of the present invention, termination stakes may be used to stabilize and increase the aesthetic appearance of landscape edging members. The termination stakes may form a cap over an exposed end of a landscape edging member, and may then be inserted via pointed ends into an underlying surface, such as, for example, the ground. A finish may be applied to the termination stake to provide color and/or to hinder environmental damage over time; the color may be selected to match or complement the landscape edging members and/or landscaping pins.

This summary provides only a general outline of some embodiments of the present invention. Many other objects, features, advantages and other embodiments of the present invention will become more fully apparent from the following detailed description and the accompanying drawings.

### BRIEF DESCRIPTION OF THE DRAWINGS

A further understanding of the various embodiments of the present invention may be realized by reference to the figures which are described in remaining portions of the specification.

FIG. 1 illustrates a perspective view of a landscape edging member in accordance with various embodiments of the present invention.

FIG. 2 illustrates a perspective view of a female end of a landscape edging member in accordance with various embodiments of the present invention.

FIG. 3 illustrates a perspective view of a male end of a landscape edging member in accordance with various embodiments of the present invention.

FIG. 4 illustrates a perspective view of a landscape edging member in accordance with various embodiments of the present invention.

FIG. 5 illustrates a perspective view of a male end of a landscape edging member in accordance with various embodiments of the present invention.

FIG. 6 illustrates a perspective view of a female end of a landscape edging member in accordance with various embodiments of the present invention.

FIG. 7 illustrates a perspective view of a connecting shim between two female ends of two landscape edging members in accordance with various embodiments of the present invention.

FIG. 8 illustrates a perspective view of a landscaping pin in accordance with various embodiments of the present invention.

FIG. 9 illustrates a front elevation view of a landscaping pin placed over a meeting joint of a male end of one landscape edging member and a female end of another landscape edging member in accordance with various embodiments of the present invention.

FIG. 10 illustrates a perspective view of a landscape edging member in accordance with various embodiments of the present invention.

FIG. 11 illustrates a perspective view of a male end of a landscape edging member in accordance with various embodiments of the present invention.

FIG. 12 illustrates a perspective view of a female end of a landscape edging member in accordance with various embodiments of the present invention.

FIG. 13 depicts a flow diagram illustrating a method for using landscape edging members in accordance with various embodiments of the present invention.

FIG. 14 depicts a flow diagram illustrating another method for using landscape edging members in accordance with various embodiments of the present invention.

FIG. 15 illustrates a perspective view of an alternative landscaping pin in accordance with various embodiments of the present invention.

FIG. 16 illustrates a front elevation view of a termination stake in accordance with various embodiments of the present invention.

FIG. 17 illustrates a front perspective view of the termination stake of FIG. 16 in accordance with various embodiments of the present invention.

FIG. 18 illustrates a side elevation view of the termination stake of FIGS. 16 and 17 over a female end of a landscape edging member in accordance with various embodiments of the present invention.

FIG. 19 illustrates a front elevation view of a piece of sheet metal after having been processed by a die cut and prior to being formed into a landscape edging member according to various embodiments of the present invention.

FIG. 20 illustrates a side elevation view of the sheet metal of FIG. 19 in accordance with various embodiments of the present invention.

FIG. 21 illustrates a front elevation view of a formed landscape edging member according to various embodiments of the present invention.

FIG. 22 illustrates a side elevation view of the landscape edging member of FIG. 21 in accordance with various embodiments of the present invention.

FIG. 23 illustrates a side cross-sectional view of a pair of drive set rollers for a roll former (shown both together in use with a sheet metal blank in between and apart in an exploded view) for making a landscape edging member according to various embodiments of the present invention.

FIG. 24 illustrates a side cross-sectional view of a pair of starting form rolls for a roll former (shown both together in use with a sheet metal blank in between and apart in an exploded view) for making a landscape edging member according to various embodiments of the present invention.

FIG. 25 illustrates a side cross-sectional view of a first turn set of rolls for a roll former (shown both together in use with a sheet metal blank in between and apart in an exploded view) for making a landscape edging member according to various embodiments of the present invention.

FIG. 26 illustrates a side cross-sectional view of a second turn set of rolls for a roll former (shown both together in use with a sheet metal blank in between and apart in an exploded view) for making a landscape edging member according to various embodiments of the present invention.

FIG. 27 illustrates a side cross-sectional view of a pair of third turning rolls for a roll former (shown both together in use with a sheet metal blank in between and apart in an exploded view) for making a landscape edging member according to various embodiments of the present invention.

FIG. 28 illustrates a side cross-sectional view of a pair of final turning rolls for a roll former (shown both together in use with a sheet metal blank in between and apart in an exploded view) for making a landscape edging member according to various embodiments of the present invention.

FIG. 29 illustrates a side cross-sectional view of a first turn set of rolls for a roll former (shown both together in use with a sheet metal blank in between and apart in an exploded view) for making a landscape edging member according to various embodiments of the present invention.

FIG. 30 illustrates a side cross-sectional view of a second turn set of rolls for a roll former (shown both together in use with a sheet metal blank in between and apart in an exploded view) for making a landscape edging member according to various embodiments of the present invention.

FIG. 31 illustrates a side cross-sectional view of a third turn set of rolls for a roll former (shown both together in use with a sheet metal blank in between and apart in an exploded view) for making a landscape edging member according to various embodiments of the present invention.

FIG. 32 illustrates a side cross-sectional view of a final turn set of rolls for a roll former (shown both together in use with a sheet metal blank in between and apart in an exploded view) for making a landscape edging member according to various embodiments of the present invention.

FIG. 33 illustrates a side cross-sectional view of a final closing set of rolls for a roll former (shown both together in use with a sheet metal blank in between and apart in an exploded view) for making a landscape edging member according to various embodiments of the present invention.

FIG. 34 illustrates a side cross-sectional view of a bead ironing set of rolls for a roll former (shown both together in use with a sheet metal blank in between and apart in an exploded view) for making a landscape edging member according to various embodiments of the present invention.

### DETAILED DESCRIPTION

Embodiments of the present invention relate generally to a landscape edging system to retain landscaping material, such as mulch, around bushes, trees, flowers, and the like. Some embodiments of the landscape edging system may also be used to act as a retaining barrier between block, brick or stone structures, such as patio decks. Embodiments of the present invention provide a landscape edging system that overcomes drawbacks associated with conventional landscaping materials by, for instance, providing simplicity of installation, aesthetically pleasing colors that blend into most landscape designs, and/or less expensive manufacturing costs. Embodiments of the present invention provide for simplicity of replacement or extension. Embodiments of the present invention provide landscaping pins that better stabilize the landscape edging and that provide a more aesthetically pleasing design.

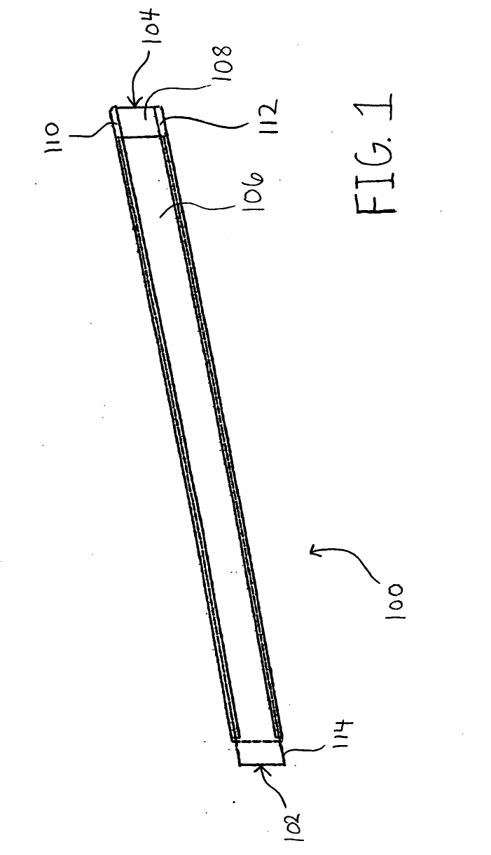

FIG. 1 illustrates a perspective view of a landscape edging member 100 in accordance with some embodiments of the present invention. Landscape edging member 100 has a male end 102 and a female end 104, and includes an inner strip 106 and an outer strip 108. Outer strip 108 may be bent or folded approximately one hundred eighty degrees over inner strip 106 to form a top hem 110 and a bottom hem 112. Outer strip 108 may be rounded at the top hem 110 and bottom hem 112 to provide a smooth edge to make edging member 100 easier to handle. Such rounding at top hem 110 and bottom hem 112 may add strength to edging member 100; for example, performing this rounding with eighteen gauge sheet metal may give outer strip 108 the strength properties of ten gauge sheet metal. Such rounding may also serve to make installed landscape edging member 100 safer for pets or humans; for example, such rounding of one or more portions of landscape edging member 100 may prevent a cutting injury to a pet's foot when the pet steps on landscape edging member 100 while running in a landscaped yard.

Top hem 110 and bottom hem 112 retain inner strip 106 within outer strip 108, such that the length of inner strip 106 may be offset with respect to the length of outer strip 108 to form female end 104 and a flange 114 at male end 102. Such a configuration gives landscape edging member 100 a modular quality that permits two or more landscape edging members to be joined by inserting flange 114 of male end 102 of one landscape edging member 100 into the top hem 110 and bottom hem 112 of female end 104 of another landscape edging member 100. Alternatively, flange 114 of male end 102 of one landscape edging member 100 may be inserted into the top hem 110 and bottom hem 112 of female end 104 of the same landscape edging member 100 to form a circular landscape edge; such a configuration may be used to, for instance, encircle the base of a tree. According to some embodiments of the present invention, such pre-formed tree rings may comprise a landscape edging member 100 pre-rolled to form rings. Such tree rings may be formed in a wide variety of sizes, diameters, and heights; for example, a pre-formed tree ring according to such embodiments may have a diameter of two feet, three feet, four feet, or five feet.

According to some embodiments of the present invention, outer strip 108 and inner strip 106 are constructed of sheet metal, such as galvanized steel; outer strip 108 may be constructed of twenty-four gauge sheet metal and inner strip 106 may be constructed of twenty-two gauge G-90 galvanized sheet metal. According to other embodiments of the present invention, various other gauges and sizes of sheet metal may be used for forming outer strip 108 and/or inner strip 106; for example, eighteen gauge, twenty gauge, sixteen gauge, or fourteen gauge sheet metal may be used for forming outer strip 108 and/or inner strip 106. Inner strip 106 and/or outer strip 108 may vary in length; for example, in some embodiments the distance between male end 102 and female end 104 is ten feet and four inches and the length of flange 114 is four inches. According to some embodiments, landscape edging member 100 stands three and three-fifths inches tall, top hem 110 is four-fifths inches wide, and bottom hem 112 is two-fifths inches wide. Flange 114 may vary in length while permitting male end 102 to interface with female end 104. Inner strip 106 may serve to add strength and/or durability to edging member 100. Landscape edging members 100 may be pre-formed to include one or more bends or turns of varying angles and degrees; for example, landscape edging members 100 may be bent at a forty-five degree angle, or may be bent to form “inside” and “outside” corners. Such pre-formed corners may include pre-formed ninety-degree corners according to various embodiments of the present invention, with a male end 102 or female end 104 formed on one or both ends of the pre-formed corner. Top hem 110 and bottom hem 112 may be formed using a roll former; flange 114 may be created using a die.

Landscape edging member 100 may have two sides, an interior side shown by FIG. 1 on which inner strip 106 is visible, and an exterior side meant to be viewed. The interior side of edging member 100 may be configured to retain landscaping materials; according to some embodiments, the entire interior side of edging member 100 may be covered with landscaping material, such as dirt. According to some embodiments of the present invention, a finish may be applied to at least one side of outer strip 108 to make the edging member 100 more durable and/or aesthetically pleasing. Color finishes may be applied to permit landscape edging member 100 to match colors of grass, flowers, water, structures, and other landscaping design elements or materials. In some embodiments, the finish is paint. In other embodiments, the finish is a polymer finish, or a polyvinylidene fluoride finish, such as a Kynar 500® finish. A Kynar 500® finish may be “baked on” to a surface of outer strip 108. Based on the disclosure provided herein, one of ordinary skill in the art will recognize various types, colors, and/or application methods for finishes, such as Kynar 500® finishes, that may be applied to outer strip 108. When the finish is applied to one side of outer strip 108, the finish may be visible along the full exterior side of edging member 100 as well as along top hem 110 and bottom hem 112 of the interior side of edging member 100. The finish may help to protect edging member 100 from damage and/or color fading caused by moisture, sunlight, temperature, contact, and/or scratching.

According to some embodiments of the present invention, a strippable film, such as a PVC strippable film, may be applied to one side of outer strip 108. The strippable film may help protect a surface of outer strip 108, and/or an applied finish, during the time between manufacturing and installation of edging member 100. Such a strippable film may help prevent scratching damage during manufacturing, transportation, and/or installation of edging member 100. The strippable film may be peeled away from the surface of outer strip 108; for example, the strippable film may be peeled away after edging member 100 has been installed.

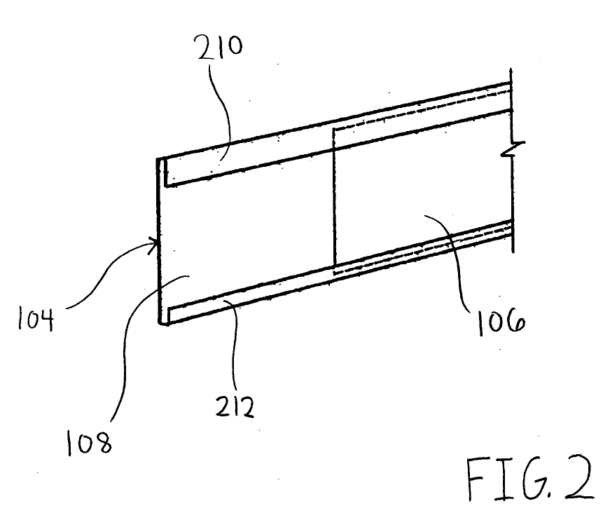

FIG. 2 depicts a female end 104 of a landscape edging member 100 in accordance with various embodiments of the present invention. Outer strip 108 may be bent or folded approximately one hundred eighty degrees over inner strip 106 to form a top hem 210 and a bottom hem 212. Outer strip 108 may be rounded at the top hem 210 and bottom hem 212 to provide a smooth edge to make edging member 100 easier to handle. Top hem 210 and bottom hem 212 retain inner strip 106 within outer strip 108, such that the length of inner strip 106 may be offset with respect to the length of outer strip 108 to form female end 104 into which flange 114 of male end 102 may be inserted.

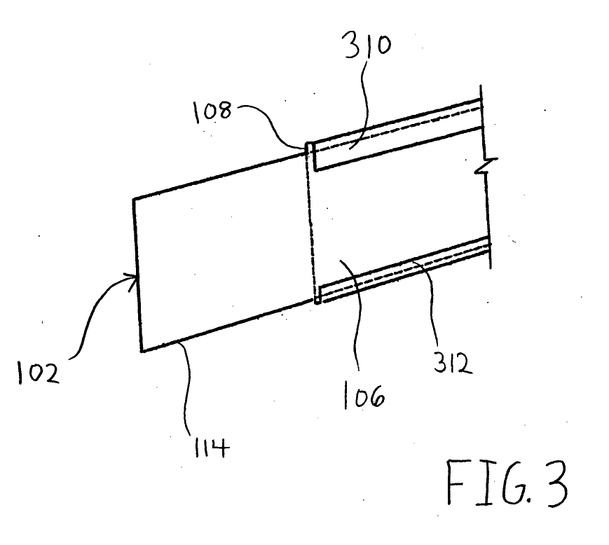

FIG. 3 depicts a male end 102 of a landscape edging member 100 in accordance with various embodiments of the present invention. Outer strip 108 may be bent or folded approximately one hundred eighty degrees over inner strip 106 to form a top hem 310 and a bottom hem 312. Outer strip 108 may be rounded at the top hem 310 and bottom hem 312 to provide a smooth edge to make edging member 100 easier to handle. Top hem 310 and bottom hem 312 retain inner strip 106 within outer strip 108, such that the length of inner strip 106 may be offset with respect to the length of outer strip 108 to form flange 114 at male end 102. According to some embodiments of the present invention, enough space is left under top hem 210, 310 to permit top hem 210, 310 of landscape edging member 100 to be inserted onto or capped over an existing or already-installed landscaping strip, such as, for example, an existing or already-installed sharp metal landscaping strip.

FIG. 4 illustrates a perspective view of a landscape edging member 400 in accordance with alternative embodiments of the present invention. Compared to landscape edging member 100, landscape edging member 400 has only an outer strip 408. Eliminating an inner strip may reduce manufacturing cost. Landscape edging member 400 has a male end 402 and a female end 404. Outer strip 408 may be bent or folded approximately one hundred eighty degrees to form a top hem 410 and a bottom hem 412. Although top hem 410 and bottom hem 412 may be folded completely over to contact outer strip 408 along most of the length of outer strip 408, a space may be formed under top hem 410 and bottom hem 412 at female end 404 to allow male end 402 to be inserted under top hem 410 and bottom hem 412 of female end 404. Such a space formed under top hem 410 and bottom hem 412 may extend from female end 404 for a length corresponding to the length of flange 414 of male end 402. For example, the space formed under top hem 410 and bottom hem 412 may correspond to the gauge thickness of sheet metal used to form edging member 400; according to some embodiments, such a space measures 0.038 inches. According to other embodiments of the present invention, enough space is left under top hem 410 to permit top hem 410 of landscape edging member 400 to be inserted onto or capped over an existing or already-installed landscaping strip, such as, for example, an existing or already-installed sharp metal landscaping strip.

Outer strip 408 may be rounded at the top hem 410 and bottom hem 412 to provide a smooth edge to make edging member 400 easier to handle. Such rounding at top hem 410 and bottom hem 412 may add strength to edging member 400; for example, performing this rounding with eighteen gauge sheet metal may give outer strip 408 the strength properties of ten gauge sheet metal. A flange 414 is formed on male end 402 of edging member 400. Such a configuration gives landscape edging member 400 a modular quality that permits two or more landscape edging members 400 to be joined by inserting flange 414 of male end 402 of one landscape edging member 400 into the top hem 410 and bottom hem 412 of female end 404 of another landscape edging member 400. Alternatively, flange 414 of male end 402 of one landscape edging member 400 may be inserted into the top hem 410 and bottom hem 412 of female end 404 of the same landscape edging member 400 to form a circular landscape edge; such a configuration may be used to, for instance, encircle the base of a tree.

According to some embodiments of the present invention, outer strip 408 is constructed of twenty gauge sheet metal, such as galvanized steel. Outer strip 408 may vary in length; for example, in some embodiments the distance between male end 402 and female end 404 is ten feet and the length of flange 414 is four inches. Alternatively, the length of flange 414 is one quarter inch; a shorter flange 414 may allow for more efficient use of a given length of sheet metal while still permitting one edging member 400 to attach to and/or interface with another edging member 400. According to some embodiments, landscape edging member 400 stands three and three-fifths inches tall, top hem 410 is four-fifths inches wide, and bottom hem 412 is two-fifths inches wide. According to other embodiments, landscape edging member 400 stands four inches tall, and top hem 410 and bottom hem 412 are each one half inch wide. Flange 414 may vary in length while permitting male end 402 to interface with female end 404. Landscape edging members 400 may be pre-formed to include one or more bends or turns of varying angles and degrees; for example, landscape edging members 400 may be bent at a forty-five degree angle. Top hem 410 and bottom hem 412 may be formed using a roll former; flange 414 may be created using a die.

Landscape edging member 400 may have two sides, an interior side shown by FIG. 4 on which hems 410, 412 are visible, and an exterior side meant to be viewed. The interior side of edging member 400 may be configured to retain landscaping materials; according to some embodiments, the entire interior side of edging member 400 may be covered with landscaping material, such as dirt. According to some embodiments of the present invention, a finish may be applied to at least one side of outer strip 408 to make the edging member 400 more durable and/or aesthetically pleasing. Color finishes may be applied to permit landscape edging member 400 to match colors of grass, flowers, water, structures, and other landscaping design elements or materials. In some embodiments, the finish is paint. In other embodiments, the finish is a polymer finish, or a polyvinylidene fluoride finish, such as a Kynar 500® finish. A Kynar 500® finish may be “baked on” to a surface of outer strip 408. Based on the disclosure provided herein, one of ordinary skill in the art will recognize various types, colors, and/or application methods for finishes, such as Kynar 500® finishes, that may be applied to outer strip 408. When the finish is applied to one side of outer strip 408, the finish may be visible along the full exterior side of edging member 400 as well as along top hem 410 and bottom hem 412 of the interior side of edging member 400. The finish may help to protect edging member 400 from damage and/or color fading caused by moisture, sunlight, temperature, contact, and/or scratching.

According to some embodiments of the present invention, a strippable film, such as a PVC strippable film, may be applied to one side of outer strip 408. The strippable film may help protect a surface of outer strip 408, and/or an applied finish, during the time between manufacturing and installation of edging member 400. Such a strippable film may help prevent scratching damage during manufacturing, transportation, and/or installation of edging member 400. The strippable film may be peeled away from the surface of outer strip 408; for example, the strippable film may be peeled away after edging member 400 has been installed.

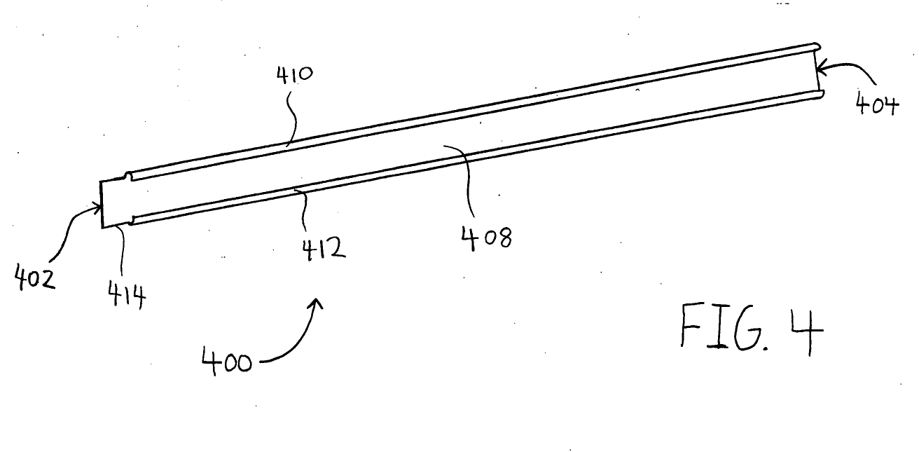

FIG. 5 depicts a male end 402 of a landscape edging member 400 in accordance with various embodiments of the present invention. Outer strip 408 may be bent or folded approximately one hundred eighty degrees to form a top hem 410 and a bottom hem 412. Outer strip 408 may be rounded at the top hem 410 and bottom hem 412 to provide a smooth edge to make edging member 400 easier to handle.

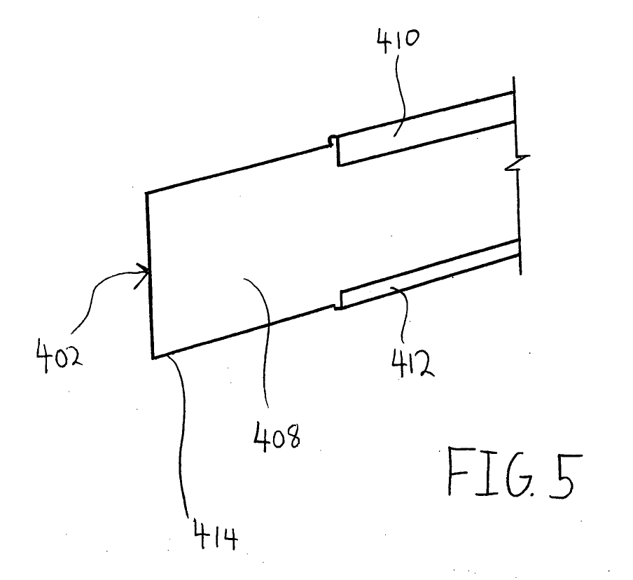

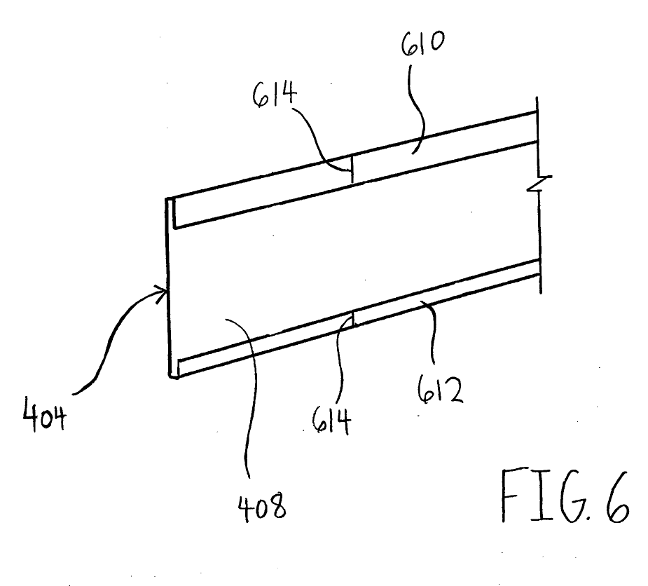

FIG. 6 depicts a female end 404 of a landscape edging member 400 in accordance with various embodiments of the present invention. Outer strip 408 may be bent or folded approximately one hundred eighty degrees to form a top hem 610 and a bottom hem 612. Outer strip 408 may be rounded at the top hem 610 and bottom hem 612 to provide a smooth edge to make edging member 400 easier to handle. Lines 614 mark an extent to which flange 414 of male end 402 of edging member 400 may be inserted into female end 404 of edging member 400. Lines 614 also mark an extent to which spaces under top hem 610 and bottom hem 612 extend from female end 404 to permit insertion of flange 414 under top hem 610 and bottom hem 612.

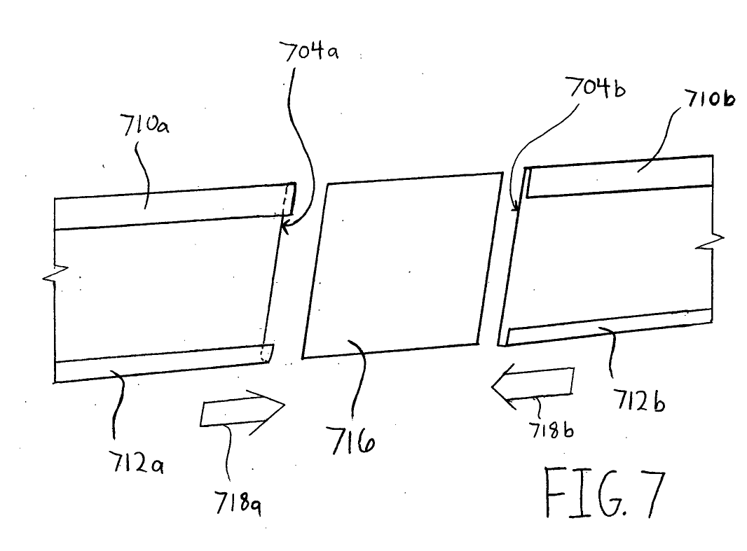

FIG. 7 illustrates a perspective view of a connecting shim 716 between two female ends 704a, 704b of two landscape edging members in accordance with various alternative embodiments of the present invention. Connecting shim 716 serves a purpose similar to flanges 114, 414; however, connecting shim 716 allows two female ends 704a, 704b to interface with one another. Such a system may allow landscape edging members to be produced with a female end at both ends. To secure female end 704a to female end 704b, female end 704a is moved in the direction indicated by arrow 718a until connecting shim 716 is inserted in top hem 710a and bottom hem 712a of female end 704a. Female end 704b may be concurrently moved in the direction indicated by arrow 718b until connecting shim 716 is inserted in top hem 710b and bottom hem 712b of female end 704b.

FIG. 8 illustrates a perspective view of a landscaping pin 800 in accordance with various embodiments of the present invention. Landscaping pin 800 may include pointed ends 804 and an outer surface 802. As shown in FIG. 8, landscaping pin 800 may have an inverted U-shaped design, and is operable to straddle a landscape edging member. Landscaping pin 800 may have a length greater than the height of a particular landscape edging member to allow pointed ends 804 of landscaping pin 800 to be inserted into an underlying surface, such as, for example, the ground, after straddling the particular edging member. Landscaping pin 800 serves to hold landscape edging members upright and in the ground.

According to some embodiments, landscaping pins 800 may be constructed of sheet metal, such as sixteen gauge or eighteen gauge galvanized sheet metal. A finish may also be applied to outer surface 802 of landscaping pin 800. In some embodiments, the finish is paint. In other embodiments, the finish is a polymer finish, or a polyvinylidene fluoride finish, such as a Kynar 500® finish. A Kynar 500® finish may be “baked on” to outer surface 802. Based on the disclosure provided herein, one of ordinary skill in the art will recognize various types, colors, and/or application methods for finishes, such as Kynar 500° finishes, that may be applied to outer surface 802. The finish may help to protect landscaping pin 800 from damage and/or color fading caused by moisture, sunlight, temperature, contact, and/or scratching. The color of landscaping pin 800 may be selected to match, resemble, or complement the color of the particular landscape edging used. According to some embodiments, landscaping pin 800 is eight inches tall, one and one-fourth inches wide, and has an inside radius of one-eighth inch to form the bend creating its inverted U-shaped configuration. A strippable and/or removable film, such as a PVC film, may also be applied to outer surface 802 to protect outer surface 802 from damage prior to or during installation.

FIG. 9 illustrates a front plan view of a landscaping pin 800 placed over a meeting line 902 of a male end 402 of one landscape edging member 904 and a female end 404 of another landscape edging member 906 in accordance with various embodiments of the present invention. Landscaping pin 800 has dual points 804 that straddle landscape edging members 904, 906 and blend in with or compliment the color of landscape edging members 904, 906. Once male end 402 of edging member 904 has been inserted into female end 404 of edging member 906, landscaping pin 800 may be placed over edging member 904 and edging member 906. Landscaping pin 800 may then be inserted into the ground by inserting pointed ends 804 into the ground. Landscaping pin 800 may be placed so as to overlap an area where edging member 904 meets edging member 906, such as at meeting line 902. Such an overlap may serve to cover the meeting line 902 from view, in some cases giving the appearance of a continuous edging member instead of a series of modular interconnected edging members. Alternatively, landscaping pins 800 may be placed over landscape edging members 904 and/or 906 at any point along landscape edging members 904 and/or 906. In some embodiments, multiple landscaping pins 800 may be used over a single edging member 904 or 906, the placement intervals depending on the desired stability and/or geometry of edging member 904 or 906. Landscaping pin 800 may also be used with edging members connected via a connecting shim 716; for instance, landscaping pin 800 may be placed over the meeting line between two female ends of two edging members connected with connecting shim 716. Dual points 804 placed over landscape edging members 904, 906 and pushed into the ground may serve to better stabilize landscape edging members 904, 906 and/or the attachment of landscape edging members 904, 906 to each other.

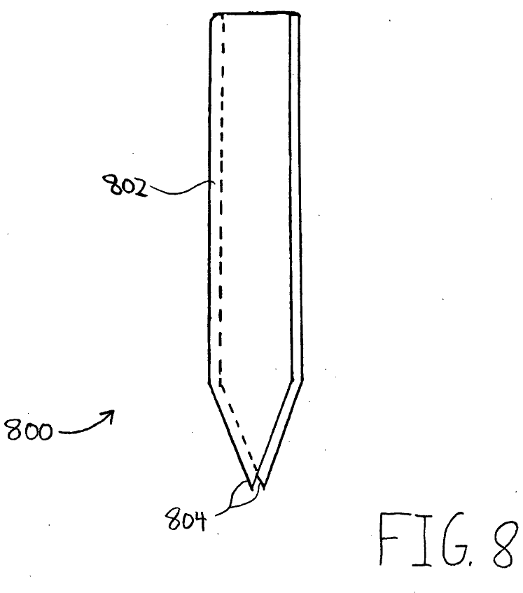

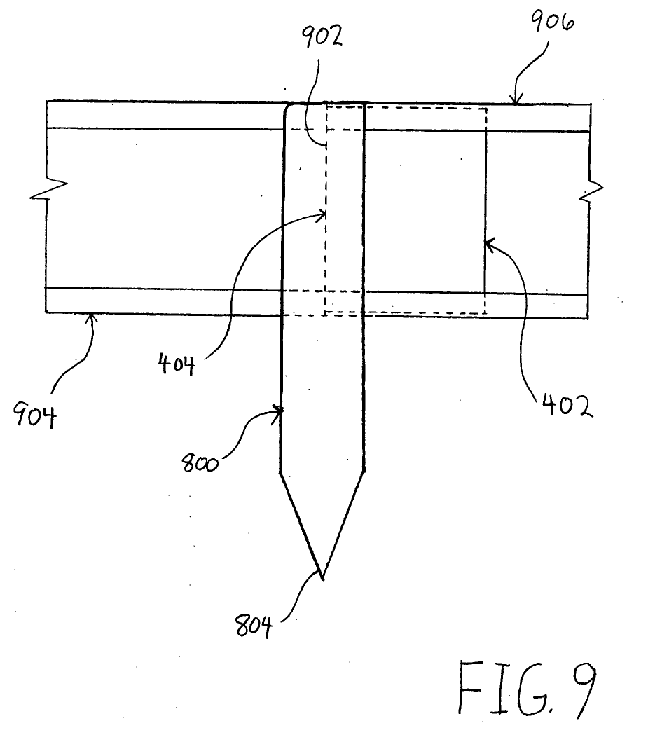

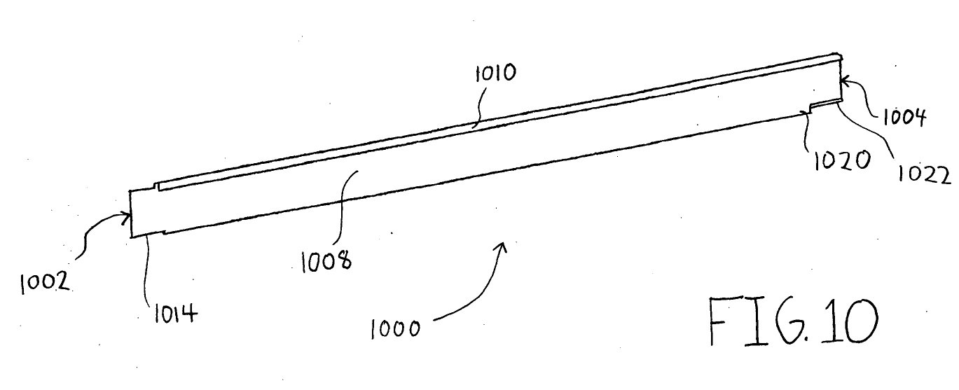

FIG. 10 illustrates a perspective view of a landscape edging member 1000 in accordance with alternative embodiments of the present invention. Compared to landscape edging member 100, landscape edging member 1000 has only an outer strip 1008. Landscape edging member 1000 has a male end 1002 and a female end 1004. Outer strip 1008 may be bent or folded approximately one hundred eighty degrees to form a top hem 1010. Although top hem 1010 may be folded completely over to contact outer strip 1008 along most of the length of outer strip 1008, a space may be formed under top hem 1010 at female end 1004 to allow male end 1002 to be inserted under top hem 1010. According to such embodiments, top hem 1010 may extend along the length of edging member 1000; however, a bottom edge 1020 may remain unbent, except for a short bottom hem 1022 at female end 1004 of edging member 1000. Bottom hem 1022 may serve to accept male end 1002 of another edging member 1000; flange 1014 of male end 1002 of one edging member 1000 may be inserted under top hem 1010 and bottom hem 1022 of female end 1004 of another edging member 1000 to connect the two edging members 1000. According to some embodiments, the length of bottom hem 1022 corresponds to the length of flange 1014 of male end 1002. For example, bottom hem 1022 may be four inches long.

Although top hem 1010 may be folded completely over to contact outer strip 1008 along most of the length of outer strip 1008, a space may be formed under top hem 1010 and bottom hem 1012 at female end 1004 to allow male end 1002 to be inserted under top hem 1010 and bottom hem 1022 of female end 1004. Such a space formed under top hem 1010 and bottom hem 1022 may extend from female end 1004 for a length corresponding to the length of flange 1014 of male end 1002. For example, the space formed under top hem 1010 and bottom hem 1022 may correspond to the gauge thickness of sheet metal used to form edging member 1000; according to some embodiments, such a space measures 0.038 inches. According to other embodiments of the present invention, enough space is left under top hem 1010 to permit top hem 1010 of landscape edging member 1000 to be inserted onto or capped over an existing or already-installed landscaping strip, such as, for example, an existing or already-installed sharp metal landscaping strip.

Such a configuration of edging member 1000 may permit bottom edge 1020 of edging member 1000 to be pushed or driven into the ground. Inserting bottom edge 1020 into the ground may increase the stability of installed edging member 1000. According to some embodiments of the present invention, edging member 1000 may be installed without the use of landscaping pins 800; according to other embodiments of the present invention, edging member 1000 may be installed with one or more landscaping pins 800 to further increase stability of installed edging member 1000.

Outer strip 1008 may be rounded at the top hem 1010 and bottom hem 1022 to provide a smooth edge to make edging member 1000 easier to handle. Such rounding at top hem 1010 and bottom hem 1022 may add strength to edging member 1000; for example, performing this rounding with eighteen gauge sheet metal may give outer strip 1008 the strength properties of ten gauge sheet metal. A flange 1014 is formed on male end 1002 of edging member 1000. Such a configuration gives landscape edging member 1000 a modular quality that permits two or more landscape edging members 1000 to be joined by inserting flange 1014 of male end 1002 of one landscape edging member 1000 into the top hem 1010 and bottom hem 1022 of female end 1004 of another landscape edging member 1000. Alternatively, flange 1014 of male end 1002 of one landscape edging member 1000 may be inserted into the top hem 1010 and bottom hem 1022 of female end 1004 of the same landscape edging member 1000 to form a circular landscape edge; such a configuration may be used to, for instance, encircle the base of a tree.

According to some embodiments of the present invention, outer strip 1008 is constructed of twenty gauge sheet metal, such as galvanized steel. Outer strip 1008 may vary in length; for example, in some embodiments the distance between male end 1002 and female end 1004 is ten feet and the length of flange 1014 is four inches. Alternatively, the length of flange 1014 is one quarter inch; a shorter flange 1014 may allow for more efficient use of a given length of sheet metal while still permitting one edging member 1000 to attach to and/or interface with another edging member 1000. According to some embodiments, landscape edging member 1000 stands three and three-fifths inches tall, top hem 1010 is four-fifths inches wide, and bottom hem 1022 is two-fifths inches wide. According to other embodiments, landscape edging member 1000 stands four inches tall, and top hem 1010 and bottom hem 1022 are each one half inch wide. Flange 1014 may vary in length while permitting male end 1002 to interface with female end 1004. Landscape edging members 1000 may be pre-formed to include one or more bends or turns of varying angles and degrees; for example, landscape edging members 1000 may be bent at a forty-five degree angle. Top hem 1010 and bottom hem 1022 may be formed using a roll former; flange 1014 may be created using a die.

Landscape edging member 1000 may have two sides, an interior side shown by FIG. 10 on which hems 1010, 1022 are visible, and an exterior side meant to be viewed. The interior side of edging member 1000 may be configured to retain landscaping materials; according to some embodiments, the entire interior side of edging member 1000 may be covered with landscaping material, such as dirt. According to some embodiments of the present invention, a finish may be applied to at least one side of outer strip 1008 to make the edging member 1000 more durable and/or aesthetically pleasing. Color finishes may be applied to permit landscape edging member 1000 to match colors of grass, flowers, water, structures, and other landscaping design elements or materials. In some embodiments, the finish is paint. In other embodiments, the finish is a polymer finish, or a polyvinylidene fluoride finish, such as a Kynar 500° finish. A Kynar 500° finish may be “baked on” to a surface of outer strip 1008. Based on the disclosure provided herein, one of ordinary skill in the art will recognize various types, colors, and/or application methods for finishes, such as Kynar 500® finishes, that may be applied to outer strip 1008. When the finish is applied to one side of outer strip 1008, the finish may be visible along the full exterior side of edging member 1000 as well as along top hem 1010 and bottom hem 1022 of the interior side of edging member 1000. The finish may help to protect edging member 1000 from damage and/or color fading caused by moisture, sunlight, temperature, contact, and/or scratching.

According to some embodiments of the present invention, a strippable film, such as a PVC strippable film, may be applied to one side of outer strip 1008. The strippable film may help protect a surface of outer strip 1008, and/or an applied finish, during the time between manufacturing and installation of edging member 1000. Such a strippable film may help prevent scratching damage during manufacturing, transportation, and/or installation of edging member 1000. The strippable film may be peeled away from the surface of outer strip 1008; for example, the strippable film may be peeled away after edging member 1000 has been installed.

FIG. 11 depicts a male end 1002 of a landscape edging member 1000 in accordance with various embodiments of the present invention. Outer strip 1008 may be bent or folded approximately one hundred eighty degrees to form a top hem 1110. According to some embodiments of the present invention, top hem 1110 may extend along the length of edging member 1000; however, a bottom edge 1120 may remain unbent. Such a configuration of edging member 1000 may permit bottom edge 1120 of edging member 1000 to be pushed or driven into the ground. Outer strip 1008 may be rounded at the top hem 1110 to provide a smooth edge to make edging member 1000 easier to handle.

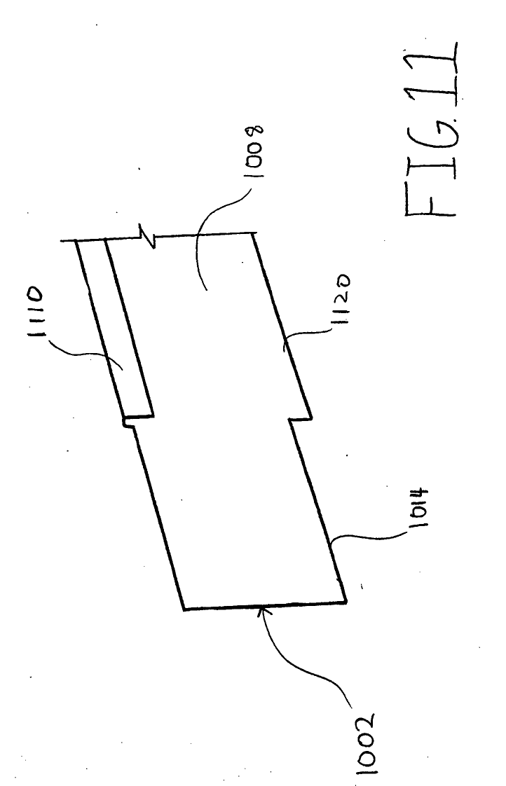

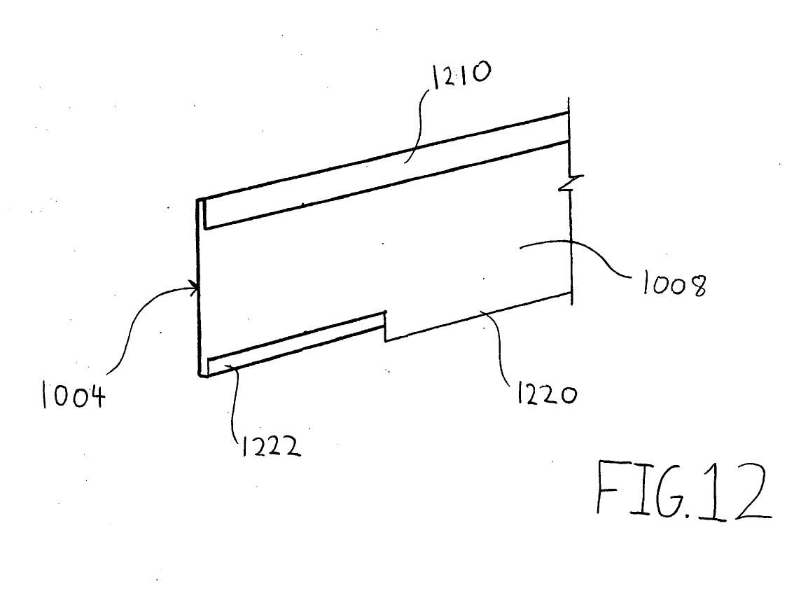

FIG. 12 depicts a female end 1004 of a landscape edging member 1000 in accordance with various embodiments of the present invention. Outer strip 1008 may be bent or folded approximately one hundred eighty degrees to form a top hem 1210. According to some embodiments of the present invention, top hem 1210 may extend along the length of edging member 1000; however, a bottom edge 1220 may remain unbent, except for a short bottom hem 1222 at female end 1004 of edging member 1000. Such a configuration of edging member 1000 may permit bottom edge 1220 of edging member 1000 to be pushed or driven into the ground. Outer strip 1008 may be rounded at top hem 1210 and bottom hem 1222 to provide a smooth edge to make edging member 1000 easier to handle. According to some embodiments of the present invention, spaces may be formed under top hem 1210 and bottom hem 1222 extending from female end 1004 to permit insertion of flange 1014 under top hem 1210 and bottom hem 1222.

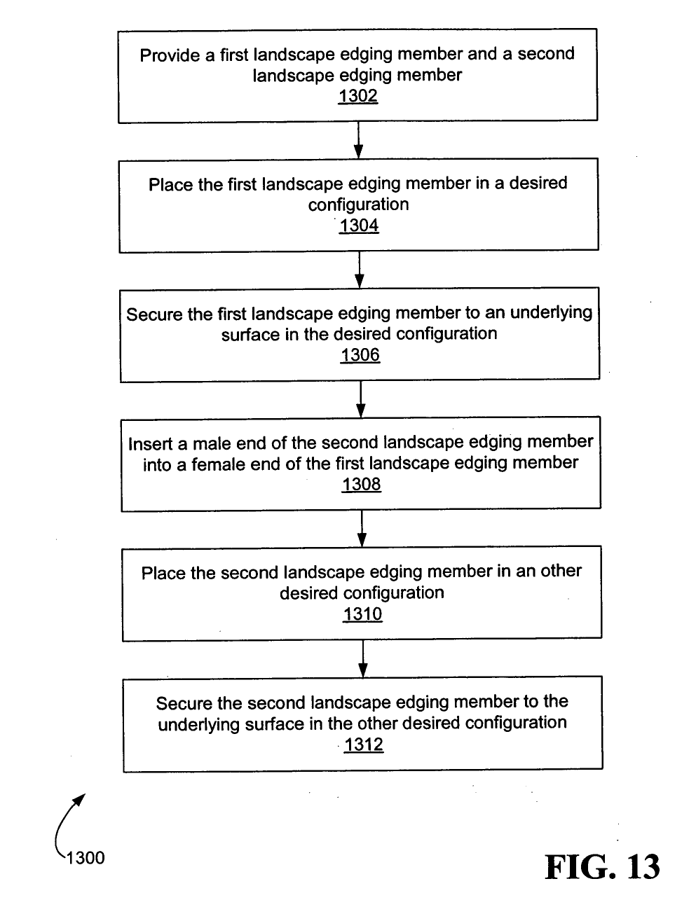

FIG. 13 depicts a flow diagram 1300 illustrating a method for using landscape edging member 100, 400, or 1000 according to various embodiments of the present invention. Flow diagram 1300 also depicts a method for using any other landscape edging member having a male end and a female end according to various embodiments of the present invention. A first and a second landscape edging member are provided (block 1302). The first and the second landscape edging members may each have a male end and a female end; for example, the first and second landscape edging members may each be landscape edging members 100, 400, or 1000. The first landscape edging member is placed in a desired configuration, such as at a particular curve or angle or bend at a desired location (block 1304). The first landscape edging member is secured to an underlying surface in the desired configuration (block 1306). For example, the underlying surface may be the ground, and the first landscape edging member may be secured to the ground with landscaping pins 800 whose pointed ends straddle the first landscape edging member and are inserted into the ground to hold the first landscape edging member to the ground in the desired configuration. Alternatively, the first landscape edging member may have an at least partially unfolded bottom edge configured for insertion into the ground; in such cases, the first landscape edging member may be secured to the ground in the desired configuration by being inserted into the ground via the unfolded bottom edge. A male end of the second landscape edging member may be inserted into the female end of the first landscape edging member (block 1308). The male end of the second landscape edging member may have a flange that fits under a top and bottom hem of the female end of the first landscape edging member to engage and hold the first landscape edging member to the second landscape edging member, so as to deter their coming apart. The second landscape edging member may be placed in a desired configuration, such as at a particular curve or angle or bend at a desired location (block 1310). The second landscape edging member is secured to an underlying surface in the desired configuration (block 1312). For example, the underlying surface may be the ground, and the second landscape edging member may be secured to the ground with landscaping pins 800 whose pointed ends straddle the second landscape edging member and are inserted into the ground to hold the second landscape edging member to the ground in the desired configuration. Alternatively, the second landscape edging member may have an at least partially unfolded bottom edge configured for insertion into the ground; in such cases, the second landscape edging member may be secured to the ground in the desired configuration by being inserted into the ground via the unfolded bottom edge.

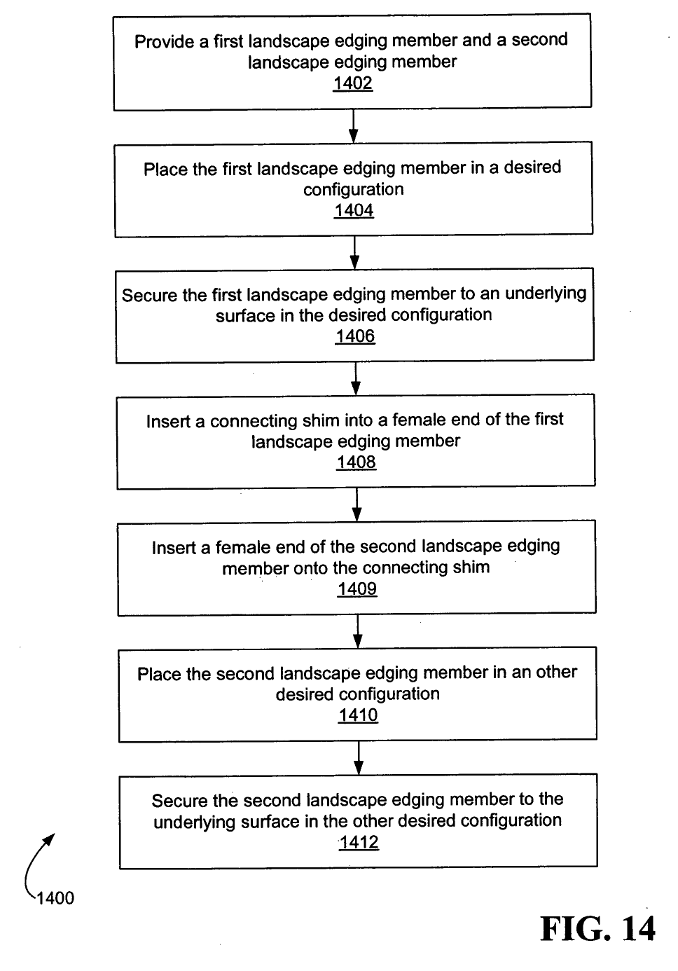

FIG. 14 depicts a flow diagram 1400 illustrating a method for using two landscape edging members each having female ends 704a, 704b according to various embodiments of the present invention. Flow diagram 1400 also depicts a method for using any other landscape edging member having a male end and a female end or two female ends according to various embodiments of the present invention. A first and a second landscape edging member are provided (block 1402). The first and the second landscape edging members may each have two female ends 704a, 704b, or, alternatively, may each have a male end and a female end. The first landscape edging member is placed in a desired configuration, such as at a particular curve or angle or bend at a desired location (block 1404). The first landscape edging member is secured to an underlying surface in the desired configuration (block 1406). For example, the underlying surface may be the ground, and the first landscape edging member may be secured to the ground with landscaping pins 800 whose pointed ends straddle the first landscape edging member and are inserted into the ground to hold the first landscape edging member to the ground in the desired configuration. Alternatively, the first landscape edging member may have an at least partially unfolded bottom edge configured for insertion into the ground; in such cases, the first landscape edging member may be secured to the ground in the desired configuration by being inserted into the ground via the unfolded bottom edge. A connecting shim may be inserted into a female end of the first landscape edging member (block 1408). The connecting shim may fit under a top and bottom hem of the female end of the first landscape edging member. A female end of the second landscape edging member may be inserted onto the connecting shim (block 1409); the connecting shim may also fit under a top and bottom hem of the female end of the second landscape edging member to hold the female end of the second landscape edging member substantially flush with the female end of the first landscape edging member. The second landscape edging member may be placed in a desired configuration, such as at a particular curve or angle or bend at a desired location (block 1410). The second landscape edging member is secured to an underlying surface in the desired configuration (block 1412). For example, the underlying surface may be the ground, and the second landscape edging member may be secured to the ground with landscaping pins 800 whose pointed ends straddle the second landscape edging member and are inserted into the ground to hold the second landscape edging member to the ground in the desired configuration. Alternatively, the second landscape edging member may have an at least partially unfolded bottom edge configured for insertion into the ground; in such cases, the second landscape edging member may be secured to the ground in the desired configuration by being inserted into the ground via the unfolded bottom edge.

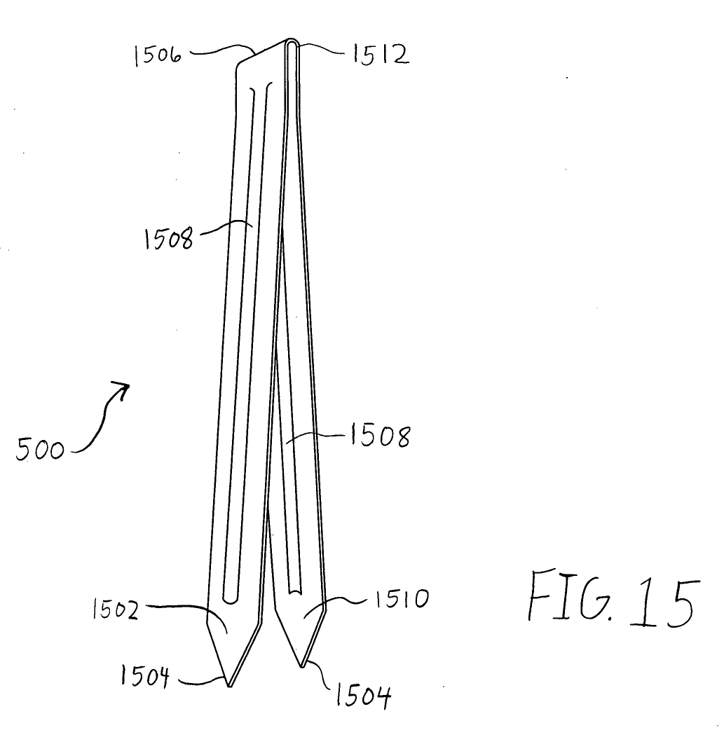

FIG. 15 illustrates a perspective view of an alternative landscaping pin 1500 in accordance with various embodiments of the present invention. Landscaping pin 1500 may include pointed ends 1504, an outer surface 1502, and an inner surface 1510. As shown in FIG. 15, landscaping pin 1500 may have an inverted U-shaped design, and is operable to straddle a landscape edging member. Landscaping pin 1500 may have a length greater than the height of a particular landscape edging member to allow pointed ends 1504 of landscaping pin 1500 to be inserted into an underlying surface, such as, for example, the ground, after straddling the particular edging member. Landscaping pin 1500 serves to hold landscape edging members upright and in the ground. Once a landscape edging member has been inserted between pointed ends 1504 and into an underlying surface, outer surface 1502 and top surface 1506 will be visible. A raised channel 1508 may be formed in each side of landscaping pin 1500; raised channel 1508 may form a raised ridge on outer surface 1502 and a corresponding indented trough on inner surface 1510. Alternatively, raised channel 1508 may form a raised ridge on inner surface 1510 and a corresponding indented trough on outer surface 1502. According to some embodiments of the present invention, landscaping pin 1500 may be formed of sheet metal; for example, landscaping pin 1500 may be formed of a sheet metal strip bent into a U-shape and die cut to form pointed ends 1504. Raised channel 1508 may be formed within the tooling used to form the U-shape of landscaping pin 1500; for example, raised channel 1508 may be formed with a brake press. According to some embodiments of the present invention, raised channel 1508 adds strength and stability to landscaping pin 1500, permitting a greater degree of force to be applied to landscaping pin 1500 without buckling or bending landscaping pin 1500. Top surface 1506 of landscaping pin 1500 may be smooth and/or rounded for increased safety and handling, before, during, and after installation.

According to some embodiments, landscaping pins 1500 may be constructed of sheet metal, such as sixteen gauge or eighteen gauge galvanized sheet metal. A finish may also be applied to outer surface 1502 of landscaping pin 1500. In some embodiments, the finish is paint. In other embodiments, the finish is a polymer finish, or a polyvinylidene fluoride finish, such as a Kynar 500® finish. A Kynar 500® finish may be “baked on” to outer surface 1502. Based on the disclosure provided herein, one of ordinary skill in the art will recognize various types, colors, and/or application methods for finishes, such as Kynar 500® finishes, that may be applied to outer surface 1502. The finish may help to protect landscaping pin 1500 from damage and/or color fading caused by moisture, sunlight, temperature, contact, and/or scratching. The color of landscaping pin 1500 may be selected to match, resemble, or complement the color of the particular landscape edging used. According to some embodiments, landscaping pin 1500 is nine inches tall, one inch wide, and has an inside radius of one-eighth inch to form the bend 1512 creating its inverted U-shaped configuration. A strippable and/or removable film, such as a PVC film, may also be applied to outer surface 1502 to protect outer surface 1502 from damage prior to or during installation. According to some embodiments of the present invention, landscaping pin 1500 may have features similar to, and may be used in a fashion similar to, that of landscaping pin 800, as described with reference to FIG. 9, above.

Referring now to FIGS. 16-18, a termination stake 1600 is depicted according to embodiments of the present invention. FIG. 16 illustrates a front elevation view of termination stake 1600 in accordance with various embodiments of the present invention. FIG. 17 illustrates a front perspective view of termination stake 1600, and FIG. 18 illustrates a side elevation view of termination stake 1600 over a female end 1804 of a landscape edging member in accordance with various embodiments of the present invention. Termination stake 1600 may include pointed ends 1602, two outer walls 1608, 1610, a top inner surface 1604, and a back inner surface 1606. As shown in FIGS. 16-18, termination stake 1600 is operable to straddle a female or male end of a landscape edging member. Termination stake 1600 may have a length greater than the height of a particular landscape edging member to allow pointed ends 1602 of termination stake 1600 to be inserted into an underlying surface, such as, for example, the ground, after the end of the particular edging member has been placed between outer walls 1608 and 1610 of stake 1600 and top inner surface 1604 resides over the top edge of the end of the particular edging member and back inner surface 1606 contacts or is in proximity with the end of the particular edging member.

Termination stake 1600 serves to hold landscape edging members upright and in the ground, and/or to cover the exposed male or female ends of landscape edging members according to various embodiments of the present invention. Once a termination stake 1600 has been placed to cover an end of a landscape edging member, such as female end 1804 of the partially-depicted landscape edging member of FIG. 18, outer surface 1604 of termination stake 1600 will be visible. According to some embodiments of the present invention, termination stake 1600 may be formed of sheet metal; for example, termination stake 1600 may be formed of a sheet metal strip die cut and bent to form the shape depicted in FIGS. 16-18 or a similar shape, and to form pointed ends 1602. To permit termination stake 1600 to be formed of a single piece of sheet metal, top inner surface 1604 may be formed under a U-shaped bend which is then bent toward the rest of the stake 1600 until top inner surface 1604 is approximately perpendicular with back inner surface 1606. The slight space, if any, between the substantially horizontal portion of termination stake 1600 and the substantially vertical portion of termination stake 1600 may form a visible gap 1702, according to some embodiments of the present invention.

According to some embodiments, termination stake 1600 may be constructed of sheet metal, such as sixteen gauge or eighteen gauge galvanized sheet metal. A finish may also be applied to outer surface 1704 of termination stake 1600. In some embodiments, the finish is paint. In other embodiments, the finish is a polymer finish, or a polyvinylidene fluoride finish, such as a Kynar 500® finish. A Kynar 500® finish may be “baked on” to outer surface 1704. Based on the disclosure provided herein, one of ordinary skill in the art will recognize various types, colors, and/or application methods for finishes, such as Kynar 500® finishes, that may be applied to outer surface 1704. The finish may help to protect termination stake 1600 from damage and/or color fading caused by moisture, sunlight, temperature, contact, and/or scratching. The color of termination stake 1600 may be selected to match, resemble, or complement the color of the particular landscape edging used. According to some embodiments, termination stake 1600 is nine inches tall, ⅝ inches wide, and has an inside radius of one-eighth inch to form the bend creating the U-shaped configuration of back inner surface 1606. A strippable and/or removable film, such as a PVC film, may also be applied to outer surface 1704 to protect outer surface 1704 from damage prior to or during installation.

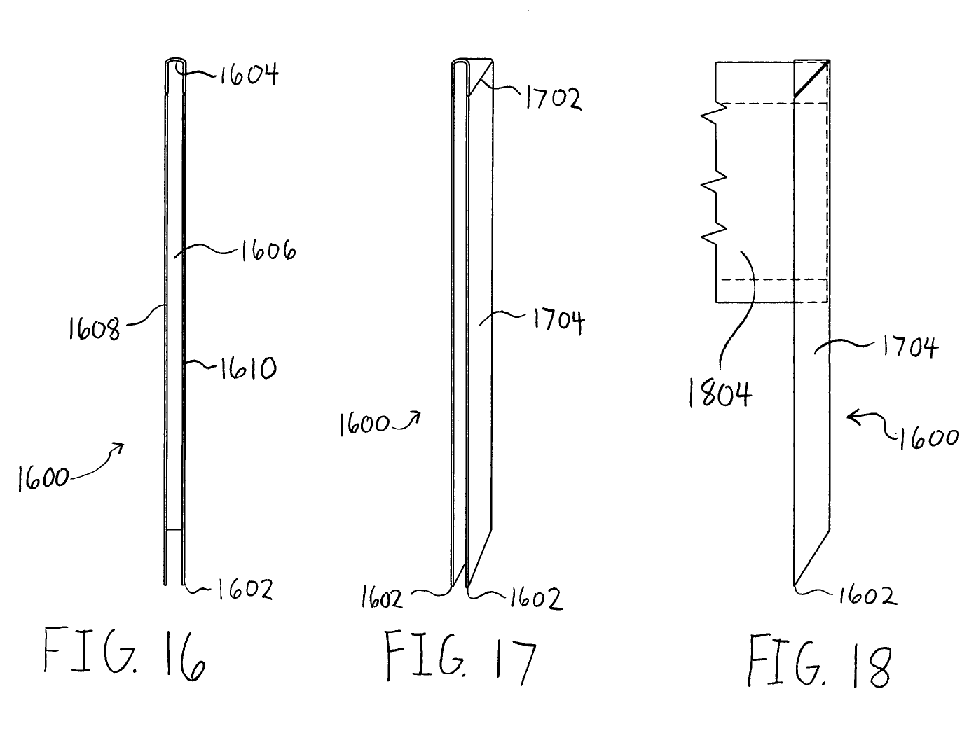

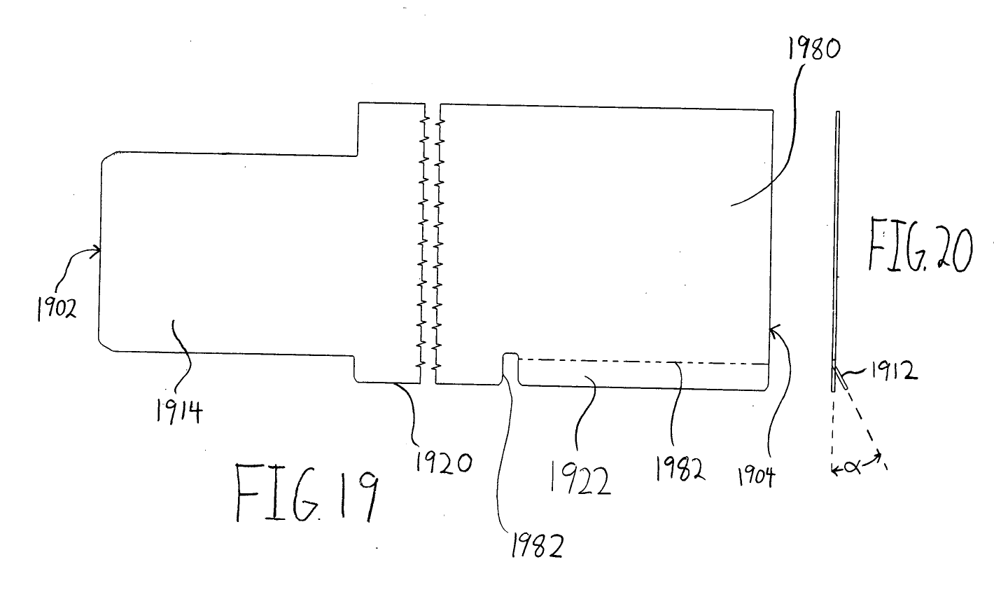

With reference to FIGS. 19-34, a system and method for fabricating a landscape edging member 1900 will now be described, according to embodiments of the present invention. FIG. 19 illustrates a front elevation view of a piece of sheet metal 1980 after having been processed by a die cut and prior to being formed into landscape edging member 1900 according to various embodiments of the present invention. FIG. 20 illustrates a side elevation view of the sheet metal 1980 of FIG. 19 in accordance with various embodiments of the present invention. FIG. 21 illustrates a front elevation view of a formed landscape edging member 1900, and FIG. 22 illustrates a side elevation view of the landscape edging member of FIG. 21 according to various embodiments of the present invention.

Using a die cut or similar tooling, a sheet metal blank 1980 is cut out of a roll of sheet metal, such as, for example, sixteen gauge cold rolled sheet metal. The die cuts an outer edge from male end 1902 to form flange 1914, and cuts a notch 1982 toward female end 1904 to leave a bottom hem flap 1922. As seen in FIG. 20, after the die cut process the sheet metal blank 1980 remains flat, including flange 1914 and a bottom edge 1920, except for the bottom hem flap 1922. Bottom hem flap 1922 is bent slightly away from the rest of blank 1980 at bend line 1982 by an angle a. According to some embodiments, angle a is approximately equal to thirty degrees. The bending of bottom hem flap 1922 may be achieved by the same die cut at substantially the same time as the rest of the sheet metal blank 1980 is cut. Such a process permits sheet metal blank 1980 to be formed in a single step, according to various embodiments of the present invention.

Because bottom hem flap 1922 is the only portion of the bottom of blank 1980 that will be bent to form a hem (bottom edge 1920 remains flat to enable it to be inserted into an underlying surface, such as the ground), bending bottom hem flap 1922 during the die cut process permits the subsequent roll forming machinery to discriminate between bottom edge 1920 and bottom hem flap 1922. Using such a one-step cutting and bending process for sheet metal blank 1980 may save time and cost in the manufacturing process, according to embodiments of the present invention. Based on the disclosure provided herein, one of ordinary skill in the art will appreciate and understand the various ways in which an apparatus (i.e. die cut, stamping machine, etc.) may be formed and/or used in order to simultaneously cut and bend a sheet metal blank such as blank 1980 as shown in FIGS. 19 and 20.

Once sheet metal blank 1980 has been formed, such as, for example, via the die cut process described above, the sheet metal blank 1980 may be fed into a roll former to create a landscape edging member 1900 with a top hem 2110 and a bottom hem 1922. Landscape edging member 1900 resembles landscape edging member 1000 of FIGS. 10-12. According to embodiments of the present invention, bottom hem 1922 extends a short distance along female end 1904 such that flange 1914 of male end may be inserted under top hem 2110 and bottom hem 1922 to modularly interconnect two or more landscape edging members 1900. Top hem 2110 extends from female end 1904 along the top of landscape edging member 1900 until it reaches the beginning of flange 1914, and serves to create a smooth and safe top edge. As seen in FIG. 22, top hem 2110 may be formed with enough space under the hem 2110 to permit landscape edging member 1900 to be inserted over existing landscape edging. Alternatively, top hem 2110 may be formed with no space under top hem 2110, such as in the instance where top hem 2110 is flattened. Bottom edge 1920 remains unbent between flange 1914 and bottom hem 1922 to permit landscape edging member 1900 to be inserted into the ground or other underlying surface.

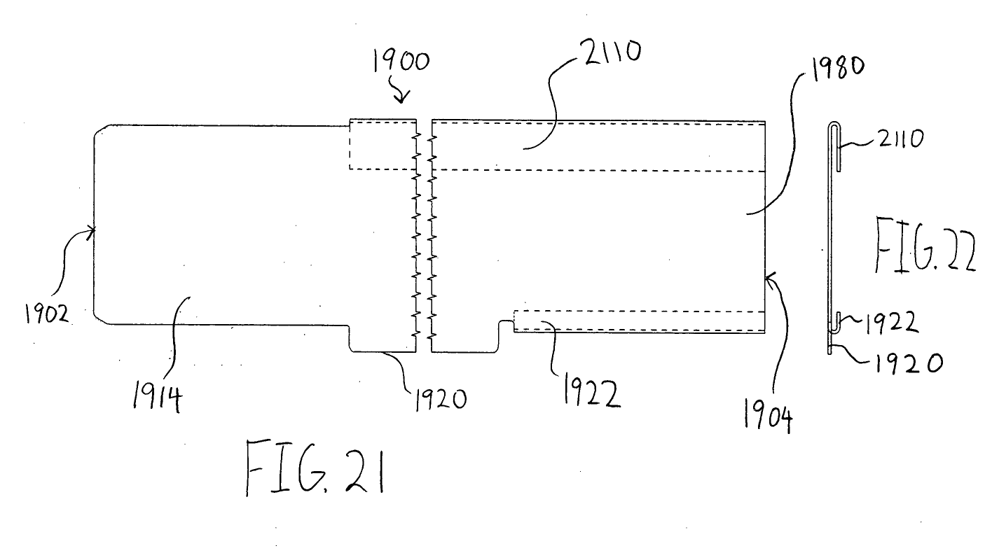

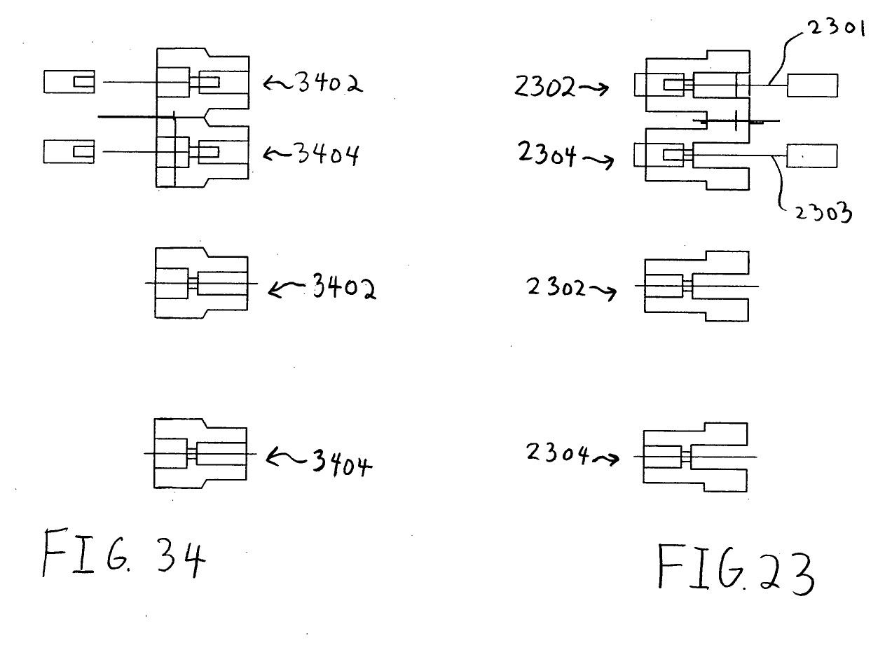

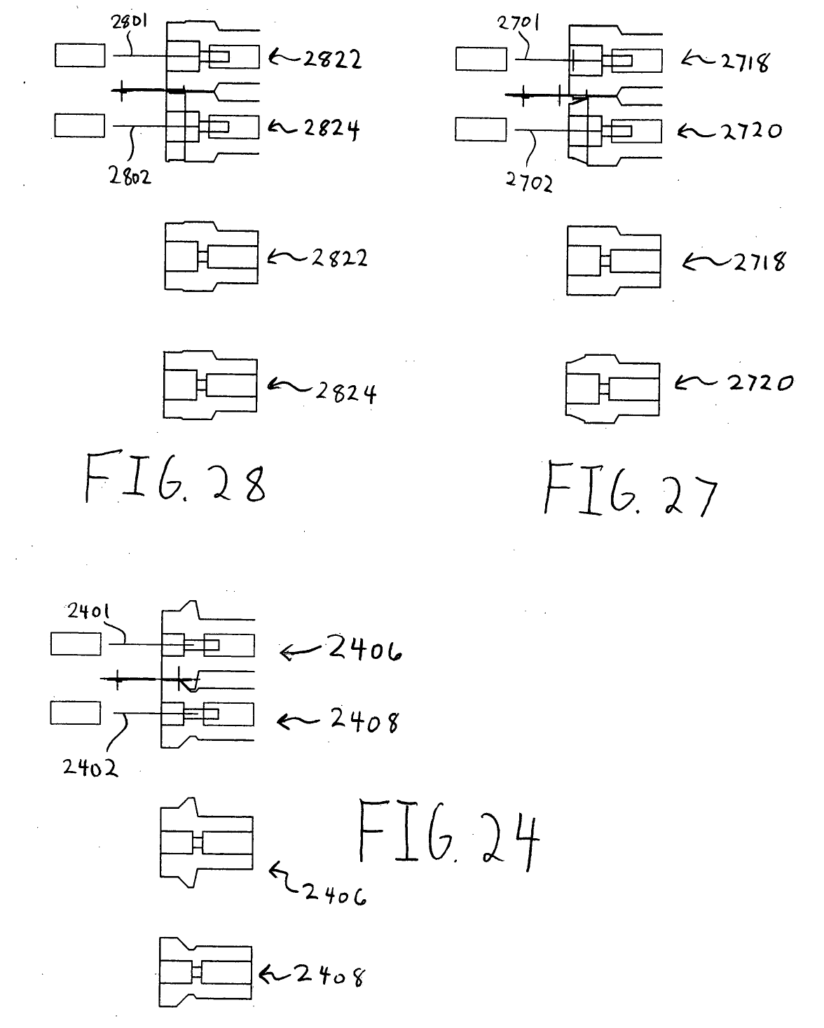

Hems 2110 and 1922 may be created in steps by the roll former, according to embodiments of the present invention. FIGS. 23-34 illustrate various sets of rollers that may be placed inline on either side of a roll former machine to transform sheet metal blank 1980 into landscape edging member 1900. The side of sheet metal blank 1980 on which is formed hem 2110 may be referred to as the “right” side of blank 1980, and the side of sheet metal blank 1980 on which is formed hem 1922 may be referred to as the “left” side of blank 1980, although such a naming convention depends on the point of view in which blank 1980 is observed, and although hems 1922 and 2110 could be formed on either or both “sides” of blank 1980. Using such a directional convention, FIGS. 24-28 depict right side rolls and FIGS. 29-33 depict left side rolls.

After the die-cut process described above, sheet metal blank 1980 may first be fed longitudinally into the roll former machine, such that bottom hem flap 1922 and bottom edge 1920 are lined up with the left side rolls. The drive set rolls 2302, 2304 of FIG. 23 engage the top and bottom of blank 1980 and propel blank 1980 through the roll former machine. Roll 2302 turns around axis of rotation 2301, and roll 2304 turns around axis of rotation 2303. The right side sets of rollers will first be described. The right side rollers of FIGS. 24-28 form hem 2110 along the entire top edge of blank 1980; therefore, the right side rollers are concerned with gradually and incrementally bending top hem 2110 through approximately 180 degrees, resulting in the hem 2110 depicted in FIG. 22. The right side of blank 1980 first passes between rollers 2406 and 2408 of FIG. 24. Roller 2406 turns around axis of rotation 2401, and roller 2408 turns around axis of rotation 2402. As blank 1980 passes between rollers 2406 and 2408, hem 2110 is bent from an approximately zero degree angle to a new angle, which may be, for example, approximately forty-five degrees.

The right side of blank 1980 may next pass between rollers 2510 and 2512 of FIG. 25. Roller 2510 turns around axis of rotation 2501, and roller 2512 turns around axis of rotation 2502. As blank 1980 passes between rollers 2510 and 2512, hem 2110 is further bent to a new angle, which may be, for example, approximately ninety degrees. The right side of blank 1980 may next pass between rollers 2614 and 2616 of FIG. 26. Roller 2616 turns around axis of rotation 2601, and roller 2614 turns around axis of rotation 2602. As blank 1980 passes between rollers 2614 and 2616, hem 2110 is further bent to a new angle, which may be, for example, approximately one hundred fifteen degrees. The right side of blank 1980 may next pass between rollers 2718 and 2720 of FIG. 27. Roller 2718 turns around axis of rotation 2701, and roller 2720 turns around axis of rotation 2702. As blank 1980 passes between rollers 2718 and 2720, hem 2110 is further bent to a new angle, which may be, for example, approximately one hundred fifty degrees. The right side of blank 1980 may next pass between rollers 2822 and 2824 of FIG. 28. Roller 2822 turns around axis of rotation 2801, and roller 2824 turns around axis of rotation 2802. As blank 1980 passes between rollers 2822 and 2824, hem 2110 is further bent to a new angle, which may be, for example, approximately one hundred eighty degrees. Rollers 2822 and 2824 may thus be a set of final closing rolls, which completes hem 2110 such that hem 2110 forms an inverted U-shape, as seen in FIG. 22. In this way, each set of rollers is configured to accept the angled output bend of the previous set of rollers and further incrementally bend the hem 2110.

Turning now to FIGS. 29-33, the left side sets of rollers will now be described, according to embodiments of the present invention. As referred to above, after the die-cut process the sheet metal blank 1980 may be fed longitudinally into the roll former machine, such that bottom hem flap 1922 and bottom edge 1920 are lined up with the left side rolls. According to some embodiments of the present invention, bottom hem flap 1922 has already been bent to a predetermined angle, such as, for example, approximately thirty degrees, by the die cut machine before it enters the roll former machine, while bottom edge 1920 remains unbent. Such a pre-bending of bottom hem flap 1922 permits the roll former machine, and particularly the left side rollers, to discriminate between bottom edge 1920 and bottom hem flap 1922.

The left side rollers of FIGS. 29-33 form hem 1922 along a short segment of the bottom edge of blank 1980 while leaving the rest of bottom edge 1920 flat; therefore, the left side rollers are concerned with gradually and incrementally bending bottom hem flap 1922 through approximately 180 degrees, resulting in the hem 1922 depicted in FIG. 22, while leaving bottom edge 1920 undisturbed. The left side of blank 1980 first passes between rollers 2904 and 2902 of FIG. 29. Roller 2904 turns around axis of rotation 2901, and roller 2902 turns around axis of rotation 2903. As blank 1980 passes between rollers 2904 and 2902, bottom hem flap 1922 is bent from a starting angle to a new angle, such as, for example, from an approximately thirty-degree angle to an approximately forty-five degree angle. Due to the unique beginning configuration of bottom hem flap 1922, bottom edge 1920 passes into a radial slot 2905 and remains unbent while bottom hem flap 1922 catches on and is bent between surfaces 2907 and 2909.

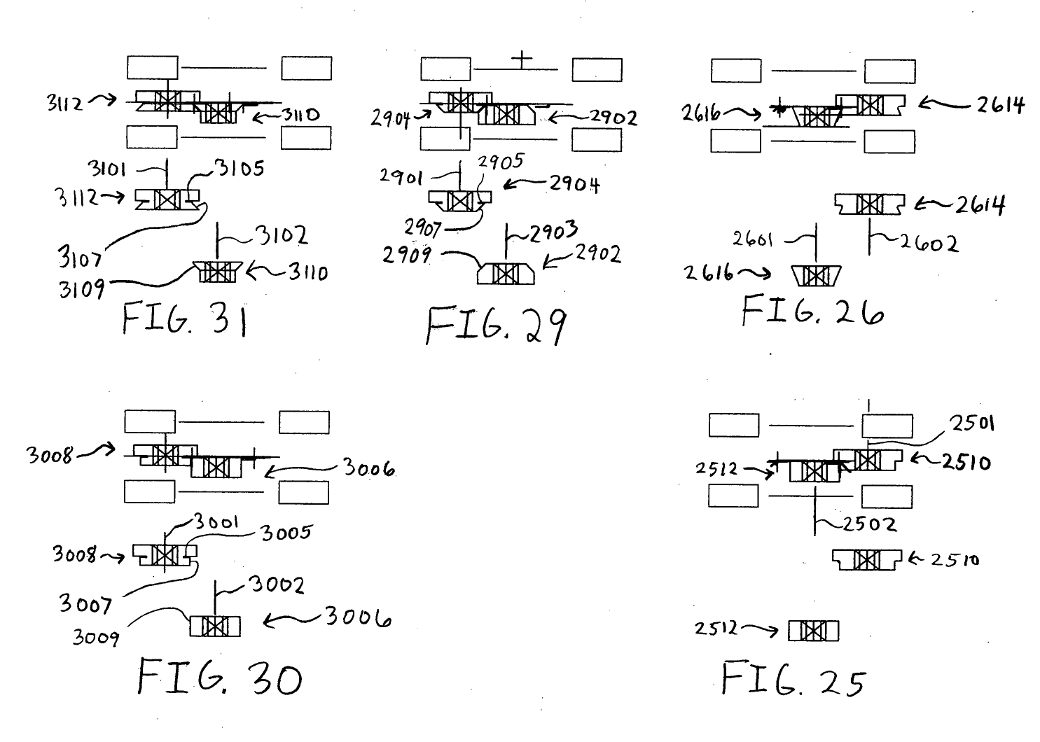

The left side of blank 1980 next passes between rollers 3006 and 3008 of FIG. 30. Roller 3008 turns around axis of rotation 3001, and roller 3006 turns around axis of rotation 3002. As blank 1980 passes between rollers 3006 and 3008, bottom hem flap 1922 is bent from a starting angle to a new angle, such as, for example, from an approximately forty-five degree angle to an approximately ninety degree angle. Due to the unique initial configuration of bottom hem flap 1922, bottom edge 1920 passes into a radial slot 3005 and remains unbent while bottom hem flap 1922 catches on and is bent between surfaces 3007 and 3009. The left side of blank 1980 next passes between rollers 3110 and 3112 of FIG. 31. Roller 3112 turns around axis of rotation 3101, and roller 3110 turns around axis of rotation 3102. As blank 1980 passes between rollers 3110 and 3112, bottom hem flap 1922 is bent from a starting angle to a new angle, such as, for example, from an approximately ninety degree angle to an approximately one hundred thirty-five degree angle. Due to the unique initial configuration of bottom hem flap 1922, bottom edge 1920 passes into a radial slot 3105 and remains unbent while bottom hem flap 1922 catches on and is bent between surfaces 3107 and 3109.

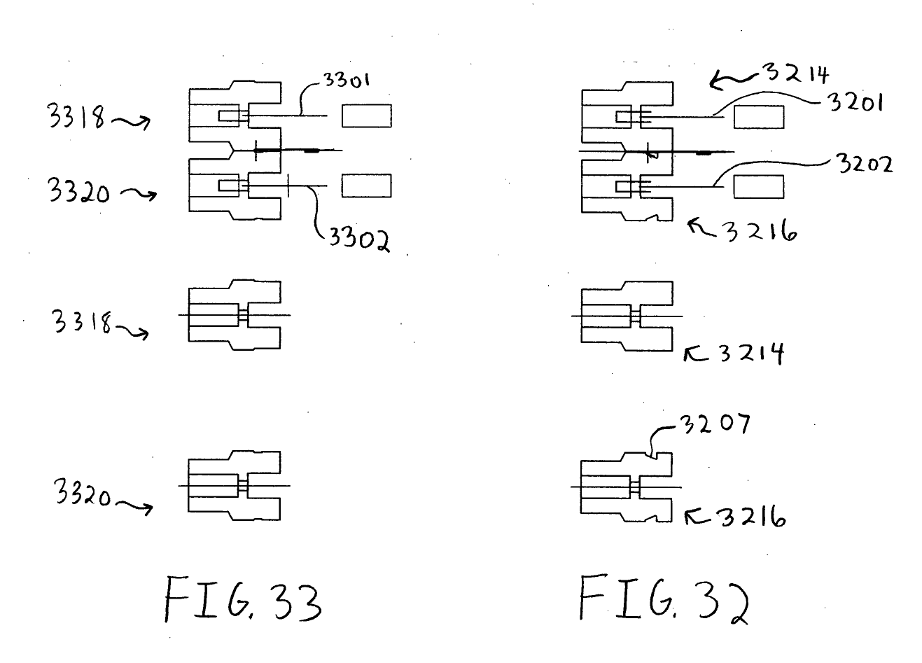

The left side of blank 1980 next passes between rollers 3214 and 3216 of FIG. 32. Roller 3214 turns around axis of rotation 3201, and roller 3216 turns around axis of rotation 3202. As blank 1980 passes between rollers 3214 and 3216, bottom hem flap 1922 is bent from a starting angle to a new angle, such as, for example, from an approximately one hundred thirty-five degree angle to an approximately one hundred fifty-five degree angle. Bottom edge 1920 passes between rollers 3214 and 3216 unbent, while bottom hem flap 1922 contacts surface 3207 for further bending. The left side of blank 1980 next passes between rollers 3318 and 3320 of FIG. 33. Roller 3318 turns around axis of rotation 3301, and roller 3320 turns around axis of rotation 3302. As blank 1980 passes between rollers 3318 and 3320, bottom hem flap 1922 is bent from a starting angle to a new angle, such as, for example, from an approximately one hundred fifty-five degree angle to an approximately one hundred eighty degree angle. Bottom edge 1920 passes between rollers 3318 and 3320 unbent, while bottom hem flap 1922 undergoes a finishing bend to bring bottom hem flap 1922 to the position depicted in FIG. 22.

FIG. 34 illustrates a side cross-sectional view of a bead ironing set of rolls for a roll former for making a landscape edging member according to various embodiments of the present invention. Once an edge of a piece of sheet metal, such as, for example, sheet metal blank 1980 has undergone the roll forming steps of FIGS. 24-28, the top edge will have a cross-sectional shape similar to top hem 2110 of FIG. 22. However, for some applications, this top hem may be flattened, leaving no space under the top hem. Once a piece of sheet metal, such as, for example, sheet metal blank 1980 has finished passing through rolls 2822 and 2824 of FIG. 28, the piece of sheet metal may then be fed between rolls 3402 and 3404 to flatten the top hem. According to some embodiments of the present invention, a piece of eighteen gauge sheet metal may be passed through the rolls of FIGS. 24-28 and 34 to form a flattened top hem.

The roll forming process is described above first in terms of the right side sequence and then in terms of the left side sequence; however, based on the disclosure provided herein, one of ordinary skill in the art will recognize that alternatively the left side sequence may be performed before the right side sequence, or the two sequences may be performed simultaneously with various rollers on the right side performing operations interspersed with operations of the various rollers on the left side, or a single right side or left side sequence may be performed in the absence of the other side sequence. Based on the disclosure provided herein, one of ordinary skill in the art will also recognize the various placements of the sets of rollers within the roll former machine that may be made in order to achieve the same or similar formation of a landscape edging member.

FIGS. 23-34 depict various possible geometries of rollers 2302, 2304, 2406, 2408, 2510, 2512, 2614, 2616, 2718, 2720, 2822, 2824, 2902, 2904, 3006, 3008, 3110, 3112, 3214, 3216, 3318, 3320, 3402 and 3404, which are each generally symmetrical about their respective axes of rotation at each axial cross-section, according to embodiments of the present invention. The roll former sequences have also been described in terms of sequential angle change bending. Based on the disclosure provided herein, one of ordinary skill in the art will recognize the various possible geometrical configurations of the various rollers that would accomplish a given bending sequence, and will recognize that such bending within the roll former may also be accomplished via fewer or more sets of rollers which cause the bending of a hem through more abrupt or more gradual incremental bending.

FIGS. 1-20 describe various embodiments of landscape edging members, landscaping pins, and termination stakes, for example. Although each such component may be made separately, such components may also be made and sold in a kit in which each component is configured to adapt and work with each other component. For example, a kit may be sold with one or more landscape edging members 1900, one or more landscaping pins 1500, and one or more termination stakes 1600 sized to fit one another. Based on the disclosure provided herein, one of ordinary skill in the art will recognize a multitude of possible kit combinations.

Embodiments of the invention have now been described in detail for purposes of clarity and understanding. However, it will be appreciated that certain changes and modifications may be practiced within the scope of the appended claims. Thus, although the invention is described with reference to specific embodiments and figures thereof, the embodiments and figures are merely illustrative, and not limiting of the invention. Rather, the scope of the invention is to be determined solely by the appended claims.

What is claimed is:

1. A landscape edging member, comprising:
a strip of sheet metal having an outer surface;
a top hem formed on the strip by bending at least part of the strip away from the outer surface and onto itself;
a bottom hem formed on the strip by bending at least part of the strip away from the outer surface and onto itself;
a male end comprising a flange;
a female end having a space formed under the top and bottom hems to receive the flange; and
a protective finish applied to the outer surface.

2. The landscape edging member of claim 1, wherein the protective finish is a polymer finish.

3. The landscape edging member of claim 1, wherein the protective finish is a polyvinylidene fluoride finish.

4. The landscape edging member of claim 1, wherein the protective finish is a Kynar 500® finish.

5. The landscape edging member of claim 1, wherein the top hem extends along the length of the strip except for the flange.

6. The landscape edging member of claim 5, wherein the bottom hem extends along the length of the strip except for the flange.

7. The landscape edging member of claim 5, wherein the bottom hem extends along the length of the strip only at the female end, the remaining length of the strip except for the male end having an unfolded bottom edge configured for insertion into an underlying surface.

8. The landscape edging member of claim 1, wherein the strip of sheet metal is a first strip of sheet metal, wherein the top hem extends along an entire length of the first strip, and wherein the bottom hem extends along the entire length, the landscape edging member further comprising:
a second strip of sheet metal substantially as long as the first strip and held to the first strip under the top hem and the bottom hem, the second strip offset lengthwise with respect to the first strip to form the male end on the second strip and the female end on the first strip.

9. A method for using the landscape edging member of claim 1, the method comprising:
providing a first landscape edging member and a second landscape edging member;
placing the first landscape edging member in a desired configuration;
securing the first landscape edging member to an underlying surface in the desired configuration;
inserting a male end of the second landscape edging member into a female end of the first landscape edging member;
placing the second landscape edging member in an other desired configuration; and
securing the second landscape edging member to the underlying surface in the other desired configuration.

10. The method of claim 9, wherein the outer surface is a first outer surface, the method further comprising:
providing a landscaping pin having a first pointed end, a second pointed end, and a second outer surface, the protective finish further applied to the second outer surface; and
wherein securing the first landscape edging member to the underlying surface comprises straddling the first landscape edging member with the first and second pointed ends of the landscaping pin and inserting the first and second pointed ends into the underlying surface.

11. A landscape edging system for modular interconnection and stabilization of landscape edging members, comprising:
a plurality of landscape edging members, each of the plurality of landscape edging members comprising:
a strip of sheet metal having a first outer surface;
a top hem formed on the strip by bending at least part of the strip away from the first outer surface and onto itself;
a bottom hem formed on the strip by bending at least part of the strip away from the first outer surface and onto itself;
a male end comprising a flange;
a female end having a space formed under the top and bottom hems to receive the flange; and
a polymer finish applied to the first outer surface; and
a plurality of landscaping pins, each of the plurality of landscaping pins comprising:
a second outer surface, the polymer finish applied to the second outer surface;
a first pointed end; and
a second pointed end, the first and second pointed ends configured to straddle the strip for insertion into an underlying surface to stabilize the strip.

12. The landscape edging system of claim 11, wherein each of the plurality of landscaping pins comprises a raised channel.

13. The landscape edging system of claim 11, wherein the polymer finish is a polyvinylidene fluoride finish.

14. A landscape edging system, comprising:
a plurality of landscape edging members, each of the plurality of landscape edging members comprising:
a strip of sheet metal having an outer surface;
a top hem formed on the strip by bending the strip away from the outer surface and onto itself;
a bottom hem formed on the strip by bending the strip away from the outer surface and onto itself;
a protective finish applied to the outer surface; and
a connecting shim configured to slide under the top hem and the bottom hem of one of the plurality of landscape edging members and the top hem and the bottom hem of an other of the plurality of landscape edging members to join the one and the other of the plurality of landscape edging members.

15. The landscape edging member of claim 14, wherein the protective finish is a polymer finish.

16. The landscape edging member of claim 15, wherein the protective finish is a polyvinylidene fluoride finish.

17. The landscape edging member of claim 14, wherein the top hem and the bottom hem extend along the entire length of the strip.

18. The landscape edging member of claim 14, wherein the bottom hem extends along the length of the strip only at each end of the strip, the remaining length of the strip having an unfolded bottom edge configured for insertion into an underlying surface.

19. The landscape edging member of claim 18, wherein the underlying surface is soil.

20. A method for using the landscape edging system of claim 14, the method comprising:
providing a first landscape edging member of the plurality of landscape edging members and a second landscape edging member of the plurality of landscape edging members;
placing the first landscape edging member in a desired configuration;
securing the first landscape edging member to an underlying surface in the desired configuration;
inserting the connecting shim at least partially under the top hem and the bottom hem of the first landscape edging member;
inserting the connecting shim at least partially under the top hem and the bottom hem of the second landscape edging member;
placing the second landscape edging member in an other desired configuration; and
securing the second landscape edging member to the underlying surface in the other desired configuration.

21. A landscape edging kit comprising:
at least one landscape edging member, the at least one landscape edging member comprising:
a strip of sheet metal having a first outer surface;
a top hem formed on the strip by bending at least part of the strip away from the first outer surface and onto itself;
a bottom hem formed on the strip by bending at least part of the strip away from the first outer surface and onto itself;
a male end comprising a flange;
a female end having a space formed under the top and bottom hems to receive the flange;
a protective finish applied to the first outer surface;
at least one landscaping pin, the at least one landscaping pin comprising:
a second outer surface, the protective finish also applied to the second outer surface;
a first pointed end; and
a second pointed end, the first and second pointed ends configured to straddle the strip for insertion into an underlying surface; and
at least one termination stake, the at least one termination stake configured to cap the male end or the female end, wherein the termination stake comprises a third pointed end and a fourth pointed end configured for insertion into the underlying surface.
